(19) United States
(12) Patent Application Publication
(10) Pub. No.: US 2002/0196838 A1
(43) Pub. Date: Dec. 26, 2002

(54) Food thermometer

(76) Inventor: Chih-Hsiung Lee, Pan-Chiao City (TW)

Correspondence Address: BACON & THOMAS, PLLC, 625 SLATERS LANE, FOURTH FLOOR, ALEXANDRIA, VA, 22314

(21) Appl. No.: 09/884,032

(22) Filed: Jun. 20, 2001

(51) Int. Cl. G01K 1/14; G01K 13/00; G01K 7/16

(52) U.S. Cl. 374/155; 374/185; 99/342

(57) ABSTRACT

A food thermometer has a holder, a temperature tube extending out from the bottom of the holder, a display mounted on the top of the holder and a solar cells mounted next to the display. The temperature tube is hollow and has a thermoresistor received therein so that the temperature from the temperature tube is able to initiate the reaction of the thermoresistor. The resistance change from the thermoresistor is sent to the circuit and then is displayed from the display so as to allow the user is have the exact temperature change of the food.

### FIELD OF THE INVENTION

The present invention relates to a food thermometer, and more particularly to a food thermometer which is able to detect the temperature change of food so as to allow the user to have the idea of how much time needed for the food to reach the desired temperature.

### BACKGROUND OF THE INVENTION

When a frozen food is undergoing a defrost process by boiling or frying, the cooker normally has to judge by experiences to tell whether the food is completely done. Sometimes when the appearance of the food turns to golden yellow, which shows that the food is almost ready, however, inside the food is actually is pretty raw. Furthermore, when processing a steak, normally there are three different kinds of cooking, tender, medium and well done. The cooker, usually an experience cooker, still judges the condition by his/her experiences to prepare the steak, which is a pretty unscientific and premature approach to prepare food. Naturally, the food prepared by experiences can not be presented with the best condition and the quality of the food is of course fluctuates.

To overcome the shortcomings, the present invention intends to provide an improved safety syringe to mitigate or obviate the aforementioned problems.

### SUMMARY OF THE INVENTION

The primary objective of the invention is to provide a food thermometer to detect the food temperature so as that the user is able to have the information of the exact temperature on the food.

In order to accomplish the foregoing objective, the food thermometer of the present invention has a plastic-made conical hollow holder, a display mounted on top of the holder, a circuit securely mounted under the display, a solar cells mounted also on top of the holder to be next to the display, a metallic temperature tube extending out from a bottom of the holder and having a thermoresistor which is able to react to temperature change and thus has a corresponding resistance change. The thermoresistor is securely received in the temperature tube and electrically connected to the circuit so that after the transmission of heat to the temperature tube, the circuit is able to sense the resistance change from the thermoresistor and then the change from the thermoresistor is displayed from the display. With such an arrangement, the user is able to have the exact information of the food temperature so that the user is able to scientifically control the food and presents it in the best condition.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the food thermometer in accordance with the present invention.

FIG. 2 is a top plan view of the food thermometer in FIG. 1.

FIG. 3 is a cross sectional view by taking line A-A of the food thermometer in FIG. 1.

FIG. 4 is a schematic view showing the application of the food thermometer of the present invention.

### DETAILED DESCRIPTION OF THE INVENTION

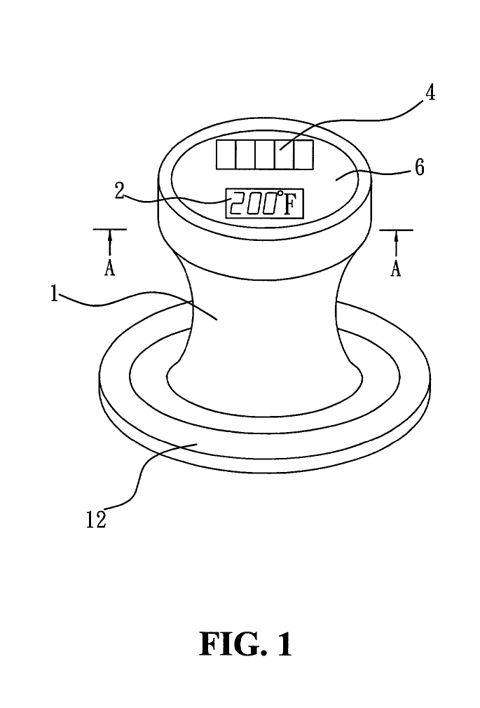

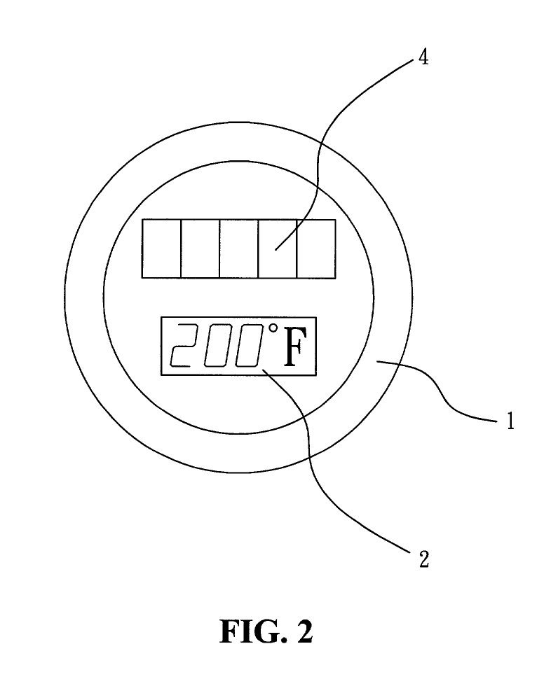

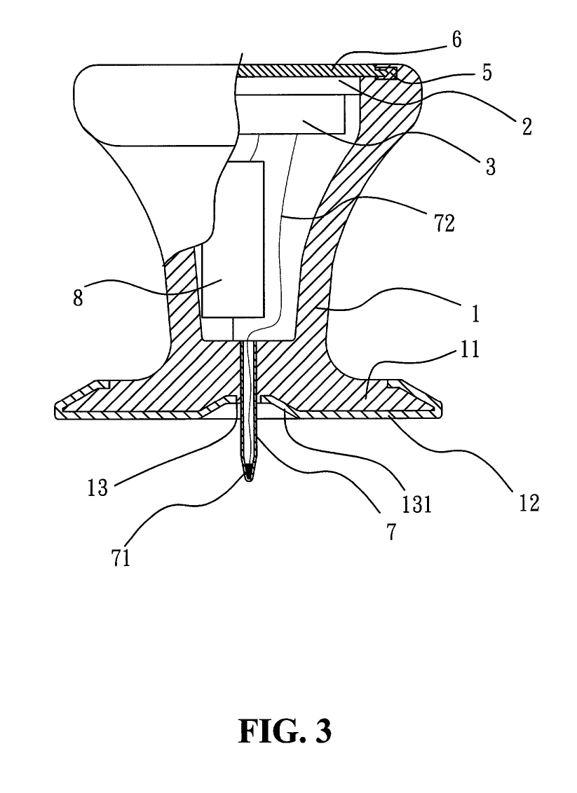

With reference to FIGS. 1, 2 and 3, the food thermometer in accordance with the present invention has a plastic-made conical hollow holder 1, a display 2 mounted on top of the holder 1, a circuit 3 securely mounted under the display 2, a solar cells 4 mounted also on top of the holder 1 to be next to the display 2, a metallic temperature tube 7 extending out from a bottom of the holder 1 and having a thermoresistor 71 which is able to react to temperature change and thus has a corresponding resistance change. The thermoresistor is securely received in the temperature tube 7 and electrically connected to the circuit 3 by means of a wire 72 so that after the transmission of heat to the temperature tube 7, the circuit 3 is able to sense the resistance change from the thermoresistor 71 and then the change from the thermoresistor 71 is displayed by the display 2. Furthermore, the food thermometer of the invention has a transparent glass 6 mounted on top of the display 2, a seal 5 mounted between the joint between the glass 6 and the display 2 to protect the display 2 from contamination and a battery compartment 8 defined inside the holder 1 to receive therein batteries for auxiliary power supply. It is noted that to prevent the holder 1 from contamination, the holder 1 has a cover 12 mounted on the bottom of the holder 1 and has an opening 13 centrally defined in the cover 12 to allow the temperature tube 7 to extend out from the holder 1. It is to be noted that the cover 12 has a recessed portion 131 defined around the periphery defining the opening 13 and the temperature tube 7 does not engage the periphery defining the opening 13 so that only the temperature from the food is able to be sensed by the temperature tube 7.

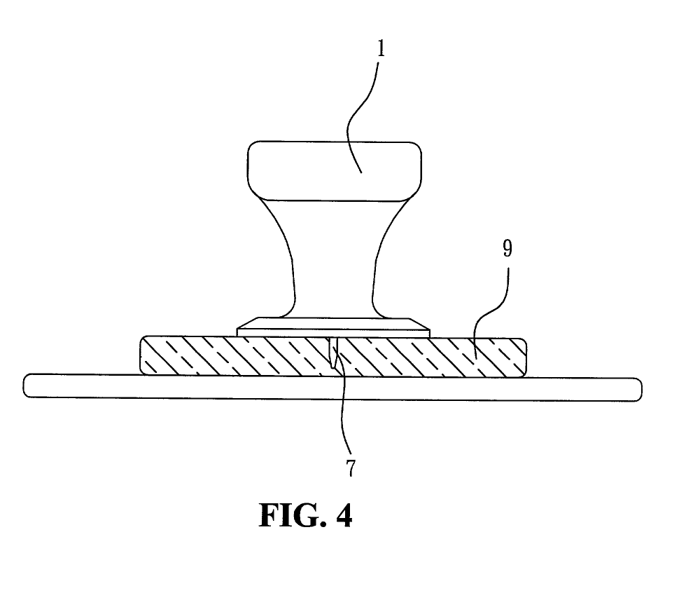

With such an arrangement, with reference to FIG. 4, the user is able to insert the temperature tube 7 into the food 9 to be prepared. The temperature change from the food 9 is able to be sensed by the temperature tube 7 and then the temperature will affect the thermoresistor 71 to react. The reaction from the thermoresistor 71 is transmitted by the wire 72 to the circuit 3. The circuit 3, after processing the signal from the wire 72, sends a signal to the display 2 and the display 2 displays the temperature of the food.

The battery compartment 8 is formed for a back-up power source. That is, when the indoor illumination is not bright to energize the solar cells 4, the circuit 3 is able to automatically switch to the back-up power for continuous functioning.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A food thermometer comprising:
a holder;
a metallic temperature tube extending out from the holder and having therein a thermoresistor;
a display securely mounted on a top of the holder;
a circuit securely mounted under the display to be electrically connected with the display and the thermoresistor;
a solar cells connected to the circuit as a power source; and
a transparent glass mounted on a top of the display and having a seal mounted around a joint between the transparent glass and the display.

2. The food thermometer as claimed in claim 1, wherein the holder is made of plastic and is conical.

3. The food thermometer as claimed in claim 2, wherein the holder further has a cover securely mounted on the bottom of the holder and having an opening defined to allow the temperature tube to extend out from the bottom of the holder.

4. The food thermometer as claimed in claim 3, wherein the cover has a recessed portion defined around a periphery defining the opening.

5. The food thermometer as claimed in claim 1, wherein the holder further has a cover securely mounted on the bottom of the holder and having an opening defined to allow the temperature tube to extend out from the bottom of the holder.

6. The food thermometer as claimed in claim 5, wherein the cover has a recessed portion defined around a periphery defining the opening.

7. The food thermometer as claimed in claim 1, further having a battery compartment formed inside the holder for receiving therein batteries as an auxiliary power source.

8. The food thermometer as claimed in claim 2, further having a battery compartment formed inside the holder for receiving therein batteries as an auxiliary power source.

9. The food thermometer as claimed in claim 3, further having a battery compartment formed inside the holder for receiving therein batteries as an auxiliary power source.

10. The food thermometer as claimed in claim 4, further having a battery compartment formed inside the holder for receiving therein batteries as an auxiliary power source.

11. The food thermometer as claimed in claim 5, further having a battery compartment formed inside the holder for receiving therein batteries as an auxiliary power source.

12. The food thermometer as claimed in claim 6, further having a battery compartment formed inside the holder for receiving therein batteries as an auxiliary power source.
